(19) United States
(12) Patent Application Publication
(10) Pub. No.: US 2012/0185788 A1
(43) Pub. Date: Jul. 19, 2012

(54) USER INTERFACE WITH VERTICAL TEXT ELEMENTS FOR AN EAST-ASIAN DEFINED LAYOUT

(75) Inventors: Jeffrey Cheng-Yao Fong, Seattle, WA (US); Kenji Nakamura, Seattle, WA (US); Daniel J. Hwang, Newcastle, WA (US); Lee Dicks Clark, Seattle, WA (US); Jeffery G. Arnold, Sammamish, WA (US)

(73) Assignee: Microsoft Corporation, Redmond, WA (US)

(21) Appl. No.: 13/150,446

(22) Filed: Jun. 1, 2011

Related U.S. Application Data
(60) Provisional application No. 61/434,341, filed on Jan. 19, 2011.

(51) Int. Cl. G06F 3/048

(52) U.S. Cl. 715/765

(57) ABSTRACT

A method and system are disclosed for displaying a user interface text element in an East-Asian mode so that system-based text can be displayed vertically on a user interface. In one embodiment, a device can dynamically switch between a Latin-based layout (horizontally displayed text elements) and an East-Asian based layout (vertically displayed text elements) based on global device settings, such as a language setting or a locale setting. Such settings can be dynamically modified by the user to change the display modes.

### CROSS REFERENCE TO RELATED APPLICATIONS

This application claims the benefit of U.S. Provisional Application No. 61/434,341, filed Jan. 19, 2011, which is incorporated herein in its entirety.

### FIELD

The present invention relates generally to a user interface, and, more particularly to displaying user interface text elements adapted for East-Asian languages.

### BACKGROUND

Many East Asian languages can be written horizontally or vertically. For example, the Chinese, Japanese and Korean languages can be oriented in either direction, as they consist mainly of disconnected syllabic units, each occupying a square block of space. Traditionally, these languages are written vertically in columns and ordered from right to left. The stroke order and stroke direction of characters (hanzi in Chinese, kanji in Japanese, hanja in Korean) is also important. It is believed the languages started this way because vertical columns allowed for writing with a brush in the right hand, while continually unrolling a sheet of paper or scroll with the left hand.

In modern times, it has become increasingly common for these languages to be written horizontally, from left to right, with successive rows going from top to bottom, under the influence of European languages, such as English. Nonetheless, modern technology, such as computers and phones, have adapted to East Asian styles, with options to display content vertically. Typically, such adaptation is accomplished by a simple reconfiguring of user content from a horizontal direction to a vertical direction through selection of a menu item in an application.

Computer operating systems, such as Microsoft Windows® and Apple Macintosh®, have a look and feel associated with their user interfaces. Generally, application programmers use a predefined set of routines (called controls or a toolbox) needed to support the graphical user interface characteristics of the computer. However, the look and feel of the user interface has not been adapted for East Asian languages. Thus, while content has been modified by individual applications to be displayed vertically, nothing has been done to adapt the entire user experience to a region or language in which a device is being used. While present solutions are usable and functional, they do not take into consideration the history and aesthetics of the East-Asian languages.

### SUMMARY

A method and system are disclosed for displaying a user interface text element in an East-Asian mode so that system-based text can be displayed vertically on a user interface.

In one embodiment, a device can dynamically switch between a Latin-based layout (horizontally displayed text elements) and an East-Asian based layout (vertically displayed text elements) based on global device settings, such as a language setting or a locale setting. Such settings can be dynamically modified by the user to change the display modes.

In another embodiment, in the East-Asian based layout, there can be a mixing with some text elements vertically and others displayed horizontally, depending on the characters used.

In yet another embodiment, East-Asian ideogram representations can be displayed instead of numerals for dates.

In still another embodiment, dynamic Tatechuyoko rendering can be used wherein two numerals are displayed as half-width characters in a single character bounding box.

In yet another embodiment, a continuum animation can transition a text element from horizontal text to vertical text so that a user can visualize an association between pages displayed.

The foregoing and other objects, features, and advantages of the invention will become more apparent from the following detailed description, which proceeds with reference to the accompanying figures.

### BRIEF DESCRIPTION OF THE DRAWINGS

FIG. 1 is an exemplary mobile device that can be used for displaying text in an Eastern-Asian mode based on locale or language settings.

FIGS. 2A and 2B show exemplary Latin-based and East-Asian based layouts.

FIGS. 3A and 3B show exemplary day and date transitions for Latin-based and East-Asian based layouts.

FIG. 4 shows an exemplary Tatechuyoko representation in Eastern-Asian layout mode.

FIGS. 5A-5C show exemplary Latin-based and East-Asian based layouts.

FIGS. 6A through 6H show animated transitions as a screen display changes from horizontal display of text to vertical display of text.

FIG. 7 is an exemplary system diagram that can be used for displaying text elements in an East-Asian mode.

FIG. 8 is a flowchart of a method for dynamic display of text elements in an East-Asian layout mode.

FIG. 9 shows cloud based services that can be used for converting to an East-Asian mode across devices using a cloud-based setting.

### DETAILED DESCRIPTION

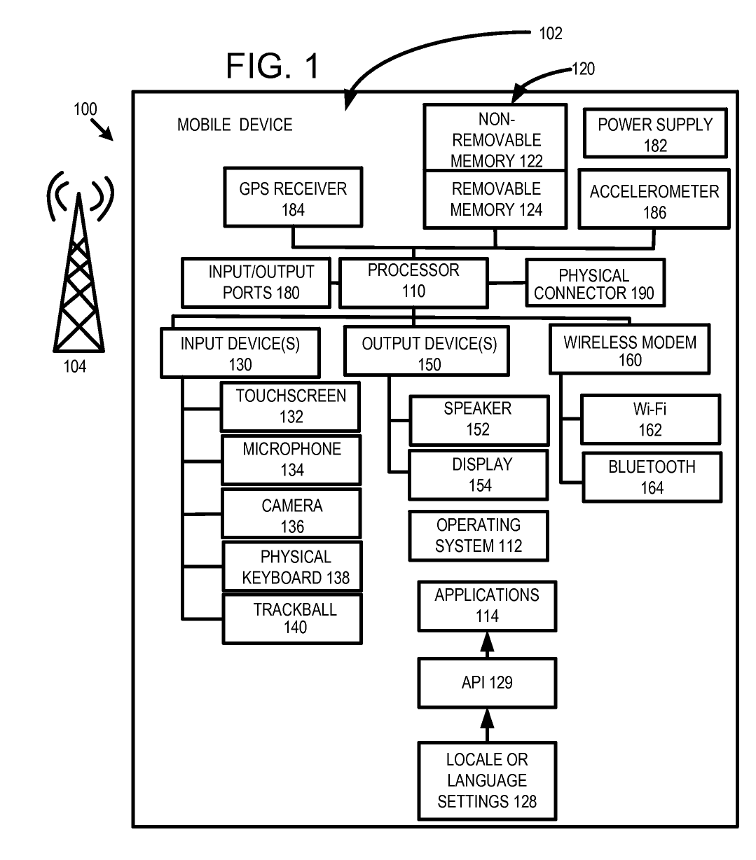

FIG. 1 is a system diagram depicting an exemplary mobile device 100 including a variety of optional hardware and software components, shown generally at 102. Any components 102 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 104, such as a cellular or satellite network.

The illustrated mobile device 100 can include a controller or processor 110 (e.g., signal processor, microprocessor, ASIC, or other control and processing logic circuitry) for performing such tasks as signal coding, data processing, input/output processing, power control, and/or other functions. An operating system 112 can control the allocation and usage of the components 102 and support for one or more application programs 114. The application programs can include common mobile computing applications (e.g., email applications, calendars, contact managers, web browsers, messaging applications), or any other computing application.

The illustrated mobile device 100 can include memory 120. Memory 120 can include non-removable memory 122 and/or removable memory 124. The non-removable memory 122 can include RAM, ROM, flash memory, a hard disk, or other well-known memory storage technologies. The removable memory 124 can include flash memory or a Subscriber Identity Module (SIM) card, which is well known in GSM communication systems, or other well-known memory storage technologies, such as “smart cards.” The memory 120 can be used for storing data and/or code for running the operating system 112 and the applications 114. Example data can include web pages, text, images, sound files, video data, or other data sets to be sent to and/or received from one or more network servers or other devices via one or more wired or wireless networks. The memory 120 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment. The memory 120 can also be used to store locale or language settings 128, which are global device settings available to substantially all application programming interfaces (APIs), such as API 129 on the mobile device. As further described below, the API exposes the locale and/or language settings to the applications 114 so that user interface text elements can be displayed in an Eastern-Asian mode in response to appropriate global device settings.

The mobile device 100 can support one or more input devices 130, such as a touch screen 132, microphone 134, camera 136, physical keyboard 138 and/or trackball 140 and one or more output devices 150, such as a speaker 152 and a display 154. Other possible output devices (not shown) can include piezoelectric or other haptic output devices. Some devices can serve more than one input/output function. For example, touchscreen 132 and display 154 can be combined in a single input/output device.

A wireless modem 160 can be coupled to an antenna (not shown) and can support two-way communications between the processor 110 and external devices, as is well understood in the art. The modem 160 is shown generically and can include a cellular modem for communicating with the mobile communication network 104 and/or other radio-based modems (e.g., Bluetooth or Wi-Fi). The wireless modem 160 is typically configured for communication with one or more cellular networks, such as a GSM network for data and voice communications within a single cellular network, between cellular networks, or between the mobile device and a public switched telephone network (PSTN).

The mobile device can further include at least one input/output port 180, a power supply 182, a satellite navigation system receiver 184, such as a Global Positioning System (GPS) receiver, an accelerometer 186, and/or a physical connector 190, which can be a USB port, IEEE 1394 (FireWire) port, and/or RS-232 port. The illustrated components 102 are not required or all-inclusive, as any components can deleted and other components can be added.

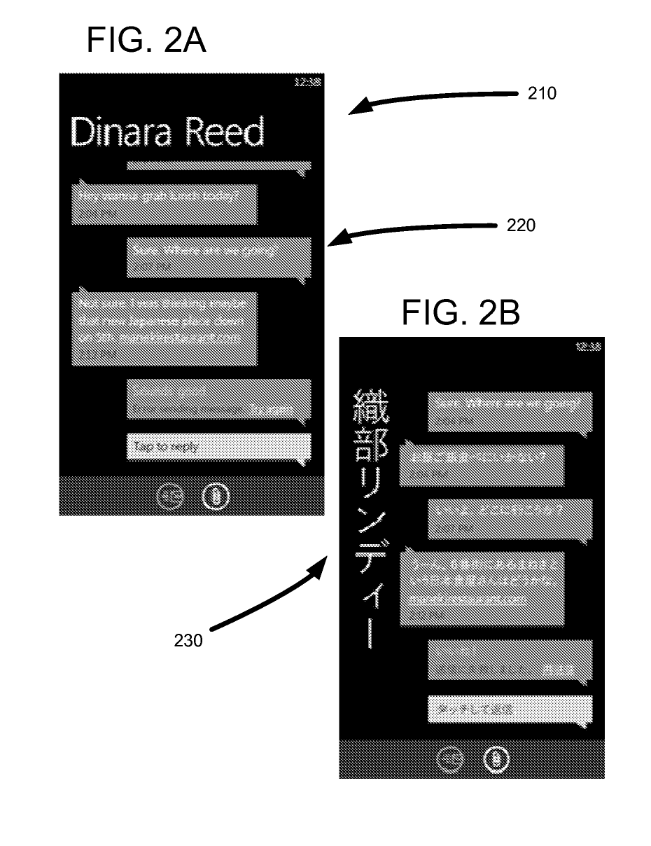

FIGS. 2A and 2B show examples of a user interface for a messaging application. In FIG. 2A, the user interface has text elements in a traditional Latin-based mode, with text positioned horizontally. For example, a user's name 210 is a sender's name associated with a message and is displayed horizontally and read left to right. Additionally, a message body is a text element, as shown at 220 and is also displayed horizontally. FIG. 2B shows that the sender's name field 210 is converted to an East-Asian mode so that the text element is displayed vertically on the user interface. Thus, the name “Dinara Reed” is converted to East-Asian characters and, additionally, the text element 230 is converted from a horizontal layout to a vertical layout in East-Asian mode. The message body text element 220 is left unchanged in a horizontal layout, but the language is converted to the East-Asian language. Thus, in East-Asian mode there can be a blending of vertical and horizontal text elements. The name text element is a system-based text element because it was not content entered by the user in the current application associated with the user interface. Instead, it was a received field from a network.

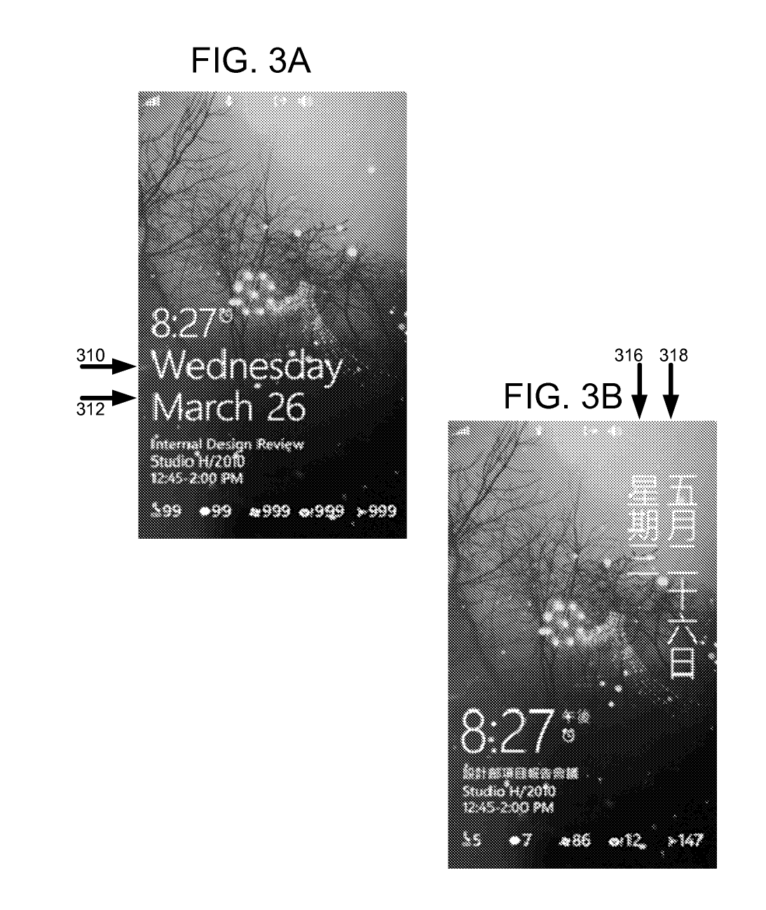

FIGS. 3A and 3B show another example user interface layout being converted from a Latin-based user interface layout to an East-Asian layout. It should be noted that the East-Asian based layout is associated with the look and feel of the user interface. In software design, look and feel is a term used in respect of a graphical user interface and can include aspects of its design, including elements such as colors, shapes, layout, and typefaces (the “look”), as well as the behavior of dynamic elements such as buttons, boxes, system text and menus (the “feel”). The term can also refer to aspects of an API, mostly to parts of an API which are not related to its functional properties, but rather its esthetic look. Look and feel in operating system user interfaces serves two general purposes. First, it provides branding, helping to identify a set of products from one company. Second, it increases ease of use, since users will become familiar with how one product functions (looks, reads, etc.) and can translate their experience to other products with the same look and feel.

The user interface of FIGS. 3A and 3B are for a lock-screen, which is a system screen not associated with any particular application. In order to change the layout of the lock screen, a user can change the global device settings. For example, the user can change a locale or language setting in order to effectuate a user interface layout change. In some embodiments, a rebooting process of the device may be needed in order to have the changes take effect. FIG. 3A shows the user interface layout in a Latin-based mode. FIG. 3B shows the user interface as converted to an East-Asian based layout with ideogram representations for dates used in the user interface layout text element. In particular, a user interface text element 310 shows a “day” field and a “date” field stored in the system. A user can then change the global device settings to indicate that the region is China or the user can change the global device language setting to Chinese. In any event, the result is shown in FIG. 3B as a change in the lock screen to an East-Asian layout mode. The day, Wednesday, is shown at 316 in Chinese and the date is shown at 318 in Chinese. The user interface text elements 316, 318 are vertically oriented to comport with the Chinese language. Notably, the text is system-based text. System-based text is text data stored on the device that is used in user interface elements. Another feature illustrated in FIGS. 3A and 3B is that the transformation from FIG. 3A to FIG. 3B includes dynamically changing the date from Arabic numerals to a character representation of the date to maintain the vertical flow. Thus, a determination is made whether the date field includes Arabic numerals, and, if so, a conversion is dynamically implemented to change such numerals to the appropriate symbolic representations corresponding to the language or region selected in the device settings.

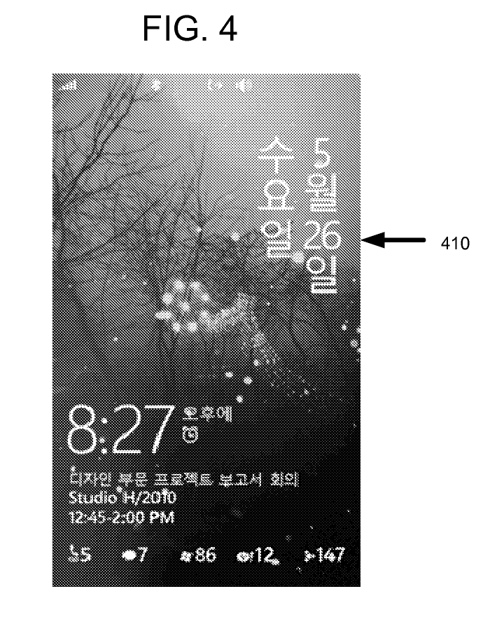

FIG. 4 shows another feature that can be used in the user interface text elements in an East-Asian mode. In this example, the Asian language selected is better presented with a Tatechuyoko effect. In particular, as shown at 410, a number 26 is displayed as two half-width characters in a single character bounding box. Thus, based on the language selected in the global device settings, an application programming interface, an operating system, or an application can search for numbers in the text to be displayed and ensure that the numbers are displayed together, side-by-side as a unit, rather than individual numerals. One technique for implementing this is using half-width characters, but that is not necessarily the only technique that can be used. Thus, the user interface text element can be searched and based on a language and numbers or characters found, the display format can be altered in response to global device settings.

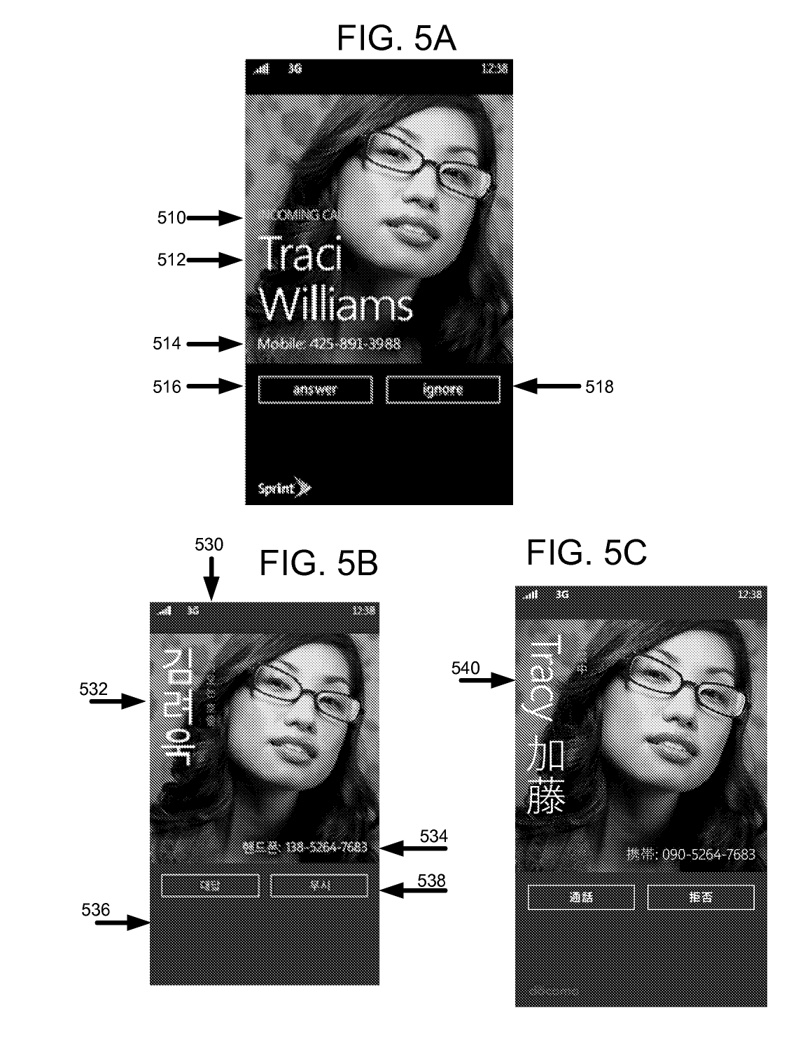

FIGS. 5A and 5B show another example of a transformation from a Latin-based horizontal layout to an Eastern-Asian based vertical layout in a cellular phone. There are a number of system-based texts in the exemplary user interface. For example, at 510 in FIG. 5A, a text message is generated by a phone that states “incoming call” in response to receipt of a phone call. The words “incoming call” are system based text, as they are stored on the phone and used to reflect the look and feel of the user interface. By contrast, user content entered into an application is not used to control the look and feel of the user interface, and should not be considered system based text. At 512, the phone matches an incoming number to a contacts list stored on the phone. If a match is found, a name of the contact is displayed. At 514, a number of the incoming call is also displayed. At 516, 518, menu buttons are displayed allowing the user to either “answer” or “ignore” the incoming call. The conversion to an Eastern-Asian based layout is shown in FIG. 5B. At 530, the word “incoming call” is converted to Korean and shown as displayed vertically. At 532, the name “Traci Williams” is displayed vertically in Korean. At 534, the word “mobile” is displayed horizontally with a phone number. Thus, in Eastern-Asian mode, there can be a mixing of both vertical and horizontal user interface text elements. Likewise, the menu buttons 536, 538 corresponding to 516, 518 are shown in horizontal format. In some embodiments, the user interface layout can treat portions of the text as Latin based and other portions as East-Asian. For example, in FIG. 5C, Traci's first name is in English letters and remains in English after the conversion to the East-Asian layout. However, her name is rotated at 540 so that it still has a vertical effect, but with the bottom of the letters along the left margin of the page. Her surname, by contrast, is displayed as vertically stacked letters, similar to FIG. 5B. Thus, portions of text can be treated in the user interface differently than other portions in the East-Asian layout mode.

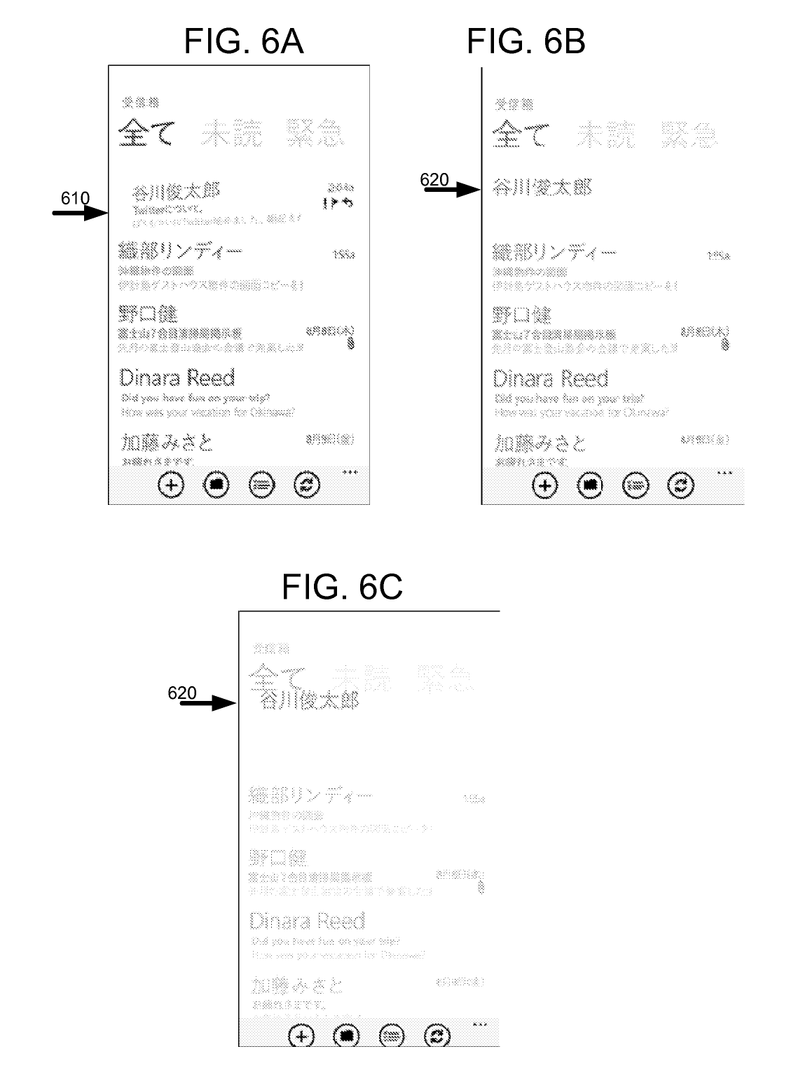

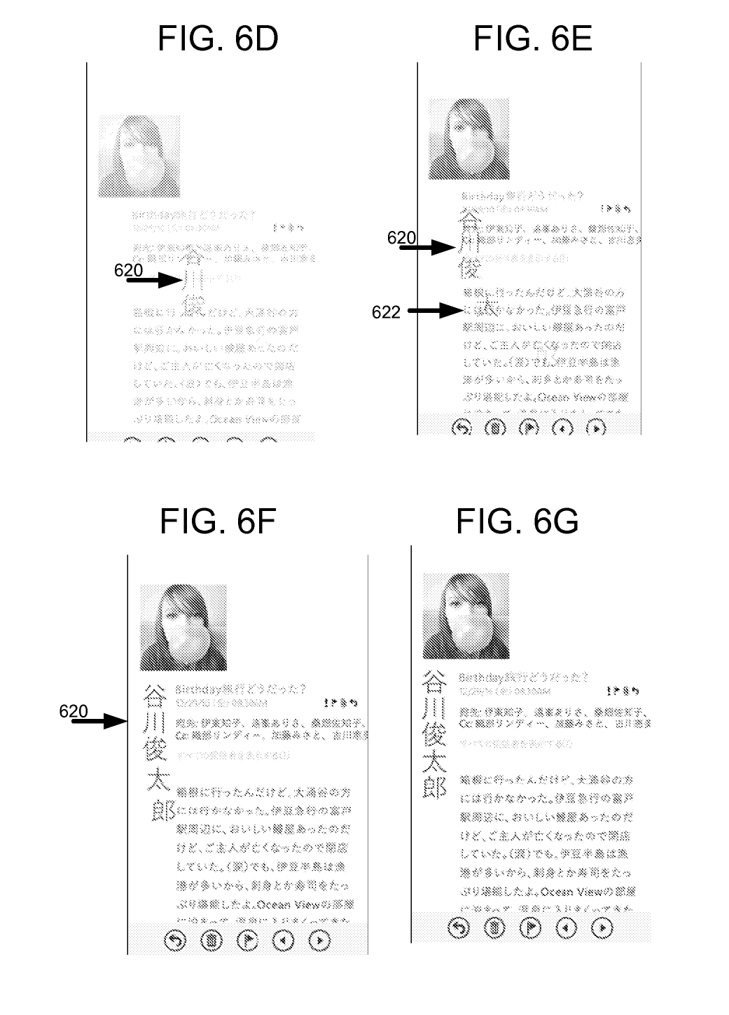

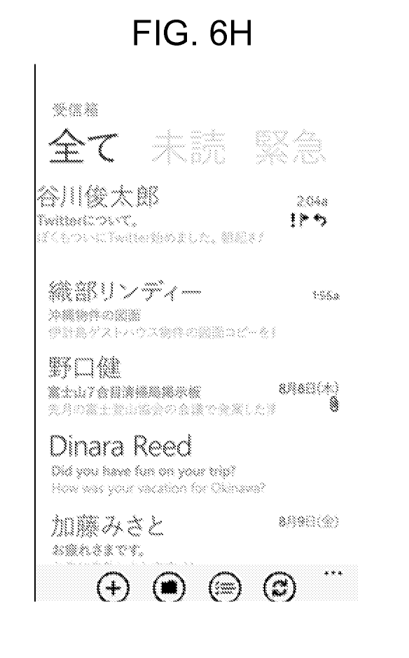

FIGS. 6A-6H shows an example of an animation that can be used as a look and feel of the user interface when transitioning between horizontal and vertical layouts. The device settings are such that the user interface is in Eastern-Asian layout mode. Some names are displayed in Chinese, while others are in English, depending on the text characters stored on the phone. In FIG. 6A, a user selects a list view item 610 and a tilt animation is applied wherein the name and associated sub-text are tilted an angle to show that a selection was made. In FIG. 6B, the sub-text associated with the name disappears and the name, shown at 620, starts an upward arching motion. In FIG. 6C, the rest of the page slides downward while the name 620 continues an upward animated motion. In FIG. 6D, a destination page transitions in with the name, shown at 620, moving from right to left across the screen as it transitions from the previously horizontal layout to a vertical layout. In FIG. 6E, the name continues to transition to its final position, but one or more trailing characters, shown at 622, are offset and lag behind the rest of the characters to illustrate a continuum transition from one page to the next. In FIG. 6F, the trailing characters are nearly caught up to the rest of the characters. In FIG. 6G, the final user interface layout is presented with the animation completed. All characters in the name are presented aligned in a vertical row. In FIG. 6H, if the user returns to the list view, the sub-text is again displayed under the name, as was the case in FIG. 6A.

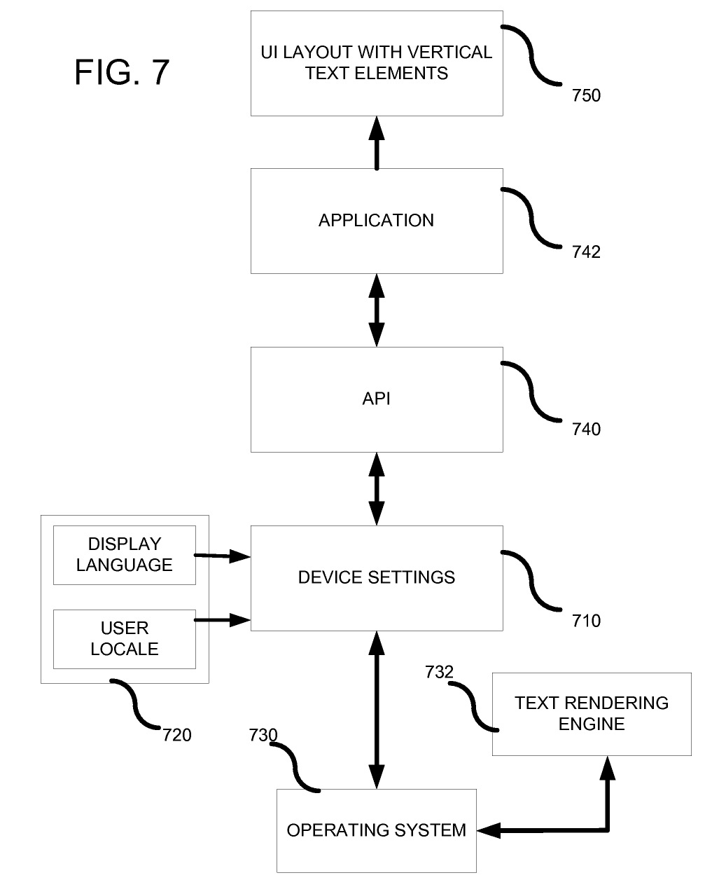

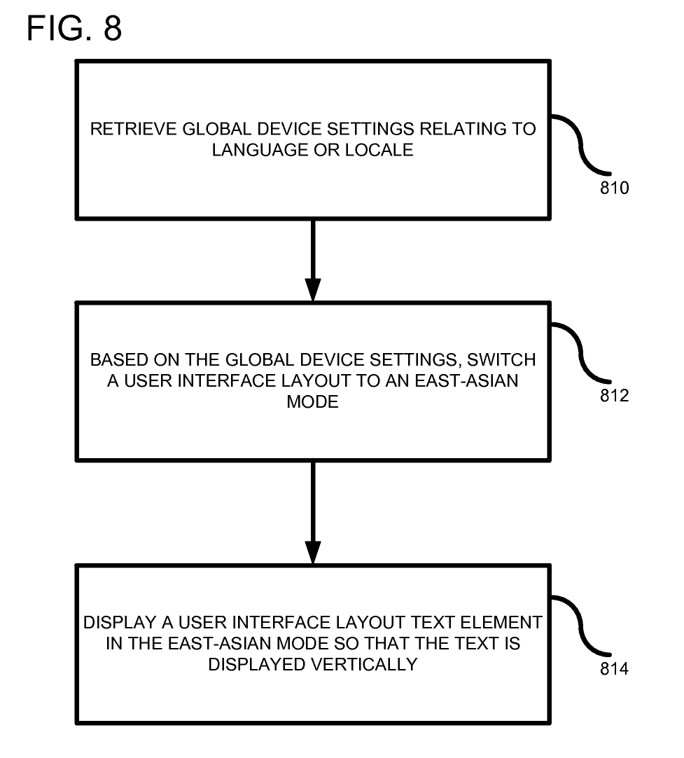

FIG. 7 is an embodiment of a system used for implementing the user interface in an East-Asian defined layout. Global device settings 710 can include a user locale and/or a display language, as shown at 720. The settings are stored in memory 120 on the computing device. The global device settings 710 are available to an operating system 730 that displays user interface elements using a text rendering engine 732. An application programming interface (API) 740 is coupled between the operating system and one or more applications 742. Using the API, applications 742 can access the global device settings and modify the user interface in response thereto. For example, the applications 742 can display a UI layout with vertical text elements, as shown at 750. Using this configuration, the operating system 730 and the applications 742 can use the global device settings to ensure the look and feel of the user interface layout is consistent across applications and the operating system. And, in particular, an East-Asian layout mode can be effectuated.

FIG. 8 shows a flowchart of a method for implementing an East-Asian user interface layout. In process block 810, global device settings relating to device locale or user language are retrieved from the system memory. In process block 812, based on the global device settings, a user interface layout is switched from a Latin-based mode to an East-Asian based mode with vertical text elements that align characters vertically on the user interface. In process block 814, a user-interface layout text element is displayed in the East-Asian mode.

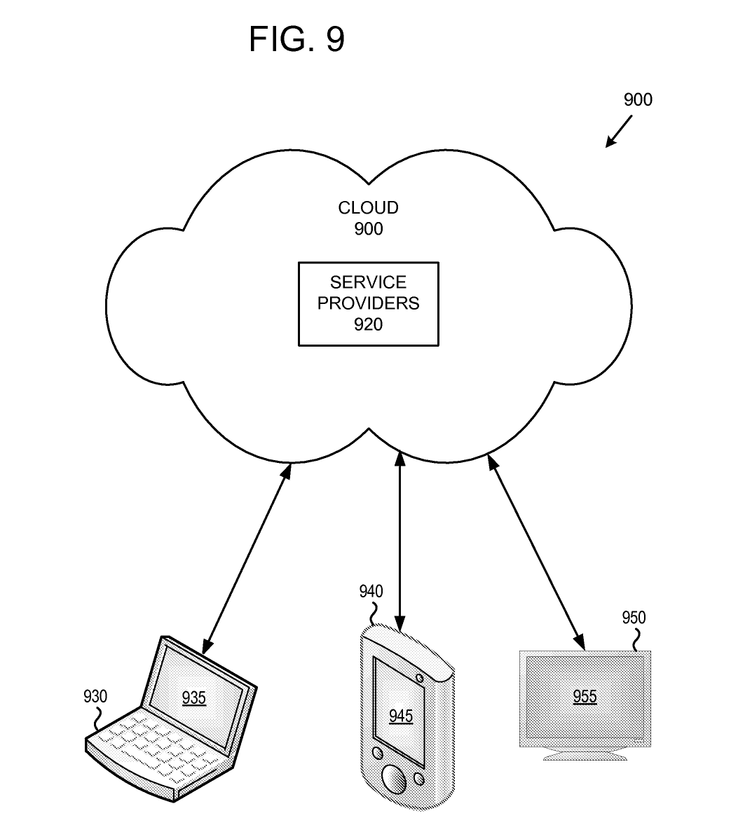

FIG. 9 illustrates a generalized example of a suitable implementation environment 900 in which described embodiments, techniques, and technologies may be implemented.

In example environment 900, various types of services (e.g., computing services) are provided by a cloud 910. For example, the cloud 910 can comprise a collection of computing devices 930, 940, 950, which may be located centrally or distributed, that provide cloud-based services to various types of users and devices connected via a network such as the Internet. The implementation environment 900 can be used in different ways to accomplish computing tasks. For example, some tasks (e.g., processing user input and presenting a user interface) can be performed on local computing devices (e.g., connected devices 930-932) while other tasks (e.g., storage of data to be used in subsequent processing) can be performed in the cloud 910.

In example environment 900, the cloud 910 provides services for connected devices 930, 940, 950 with a variety of screen capabilities. Connected device 930 represents a device with a computer screen 935 (e.g., a mid-size screen). For example, connected device 930 could be a personal computer such as desktop computer, laptop, notebook, netbook, or the like. Connected device 940 represents a device with a mobile device screen 945 (e.g., a small size screen). For example, connected device 940 could be a mobile phone, smart phone, personal digital assistant, tablet computer, and the like. Connected device 950 represents a device with a large screen 955. For example, connected device 950 could be a television screen (e.g., a smart television) or another device connected to a television (e.g., a set-top box or gaming console) or the like. One or more of the connected devices 930, 940, 950 can include touch screen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 900. For example, the cloud 910 can provide services for one or more computers (e.g., server computers) without displays.

Services can be provided by the cloud 910 through service providers 920, or through other providers of online services (not depicted). For example, cloud services can be customized to the screen size, display capability, and/or touch screen capability of a particular connected device (e.g., connected devices 930, 940, 950).

In example environment 900, the cloud 910 provides the technologies and solutions described herein to the various connected devices 930-932 using, at least in part, the service providers 920. For example, the service providers 920 can provide a centralized solution for various cloud-based services. The service providers 920 can manage service subscriptions for users and/or devices (e.g., for the connected devices 930, 940, 950 and/or their respective users). For example, the global device settings can be set in the cloud, which can extend to all platforms that a user has to change the user interface layout across devices.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., non-transitory computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques as well as any data created and used during implementation of the disclosed embodiments can be stored on one or more computer-readable media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

Although the embodiments herein focus mostly on user interface text elements, the embodiments described can be extended to menu items that are displayed vertically in an East-Asian layout mode. For example, drop-down boxes can be displayed vertically as well as other menu items.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

We claim:

1. A method of displaying a user interface in an East Asian-defined layout on a computing device, comprising:
retrieving global device settings relating to language or locale that are available to substantially all application programming interfaces running on the computing device;
based on the global device settings, switching a user interface layout to an East-Asian mode;
displaying a user interface layout text element in the East-Asian mode so that system-based text is displayed vertically on the user interface.

2. The method of claim 1, further including dynamically displaying East-Asian ideogram representations for dates in the user interface layout text element.

3. The method of claim 1, wherein the user interface text element includes two half-width characters in a single character bounding box.

4. The method of claim 1, further comprising:
displaying text horizontally in a first user interface screen;
in response to user input, transitioning to a second user interface screen; and
animating the horizontally displayed text as it transitions to vertically displayed text.

5. The method of claim 4, wherein the horizontally displayed text is transitioned to vertically displayed text in order to show a relationship between the first user interface screen and the second user interface screen.

6. The method of claim 4, wherein animating includes treating some characters in the text differently from other characters during the transition.

7. The method of claim 1, wherein the global device settings are default settings for the computing device that are accessible by an operating system on the computing device.

8. The method of claim 1, further including determining that a first portion of the text is latin-based characters and a second portion of the text is East-Asian text, and displaying the first and second portions in different formats in the user interface layout text element.

9. The method of claim 1, wherein the system-based text includes one or more of the following: a time field as maintained by the computing device, a date field as maintained by the computing device, and a name field that is received from a network communication.

10. The method of claim 1, further including displaying a menu item in an application in the East-Asian mode.

11. The method of claim 1, wherein the global device settings are retrievable by an application through an application programming interface.

12. The method of claim 1, where a text rendering engine is used to perform the displaying.

13. The method of claim 1, further including determining whether the text in East-Asian mode is a Latin-based text and, if so, rotating the Latin-based text and displaying it vertically.

14. A system for displaying a user interface in an East Asian-defined layout on a computing device, comprising
a memory for storing global device settings including at least one of a display language setting or a user locale setting;
an application programming interface having a module that is accessible by an application for switching a user interface layout from a Latin-based to an East-Asian based mode when the display language setting is an Asian language or the user locale setting is an Asian country; and
a display for displaying a user interface layout text element in the East-Asian based mode so that system-based text is displayed vertically on the user interface.

15. The system of claim 14, further including a text rendering engine coupled to the display for rendering the system-based text vertically.

16. The system of claim 15, wherein the text rendering engine dynamically displays East-Asian ideogram representations for dates in the user interface layout text element.

17. A method of displaying a user interface in an East Asian-defined layout on a computing device, comprising:
displaying a user interface layout text element horizontally;
receiving a request to change global device settings relating to language or locale that are available to substantially all application programming interfaces running on the computing device;
accessing a module in an application programming interface that exposes the global device settings to an application;
based on the global device settings, switching a user interface layout to an East-Asian mode so that the user interface layout text element is displayed vertically.

18. The method of claim 17, further comprising:
displaying text horizontally in a first user interface screen;
in response to user input, transitioning to a second user interface screen; and
animating the horizontally displayed text as it transitions to vertically displayed text.

19. The method of claim 17, further including dynamically displaying East-Asian ideogram representations for dates in the user interface layout text element.

20. The method of claim 17, wherein the user interface text element includes two half-width characters in a single character bounding box.
